(19) United States
(12) Patent Application Publication
(10) Pub. No.: US 2026/0215610 A1
(43) Pub. Date: Jul. 30, 2026

(54) PORTAFILTER AND COFFEE MACHINE

(71) Applicant: Tsann Kuen (Zhangzhou) Enterprise Co., Ltd., Zhangzhou City (CN)

(72) Inventors: Ruifeng CAI, Zhangzhou City (CN); Mengxin HAN, Zhangzhou City (CN); Jiawen YANG, Zhangzhou City (CN)

(21) Appl. No.: 19/440,970

(22) Filed: Jan. 6, 2026

(30) Foreign Application Priority Data
Jan. 24, 2025 (CN) 202520168543.8

(51) Int. Cl. A47J 31/06; A47J 31/44

(52) U.S. Cl. CPC A47J 31/0663; A47J 31/446

(57) ABSTRACT

The present invention provides a portafilter and a coffee machine. The portafilter includes a filter body and a filter basket. The filter body has a receiving chamber. The filter basket is assembled in the receiving chamber of the filter body. The filter basket has a bottom filter mesh. A central region of the bottom filter mesh has a plurality of bottom filtration holes provided at intervals. A coffee extract flows from the bottom filtration holes in the central region of the bottom filter mesh, and a water jet is formed in the central region and flows out in a concentrated way. In this way, there is no need for a baffle structure, thereby simplifying the structure and reducing costs.

### CROSS-REFERENCE TO RELATED APPLICATION

This application claims priority to Chinese Patent Application 202520168543.8, filed on 24 January 2025, which is incorporated herein by reference.

### TECHNICAL FIELD

The present invention relates to the field of coffee machines, and specifically to a portafilter and a coffee machine.

### BACKGROUND

A conventional coffee machine generally includes a coffee machine body and a portafilter installed on the coffee machine body and serving as a brewing device. Ground coffee is placed inside the portafilter, then the portafilter is mounted onto the coffee machine body, and high-pressure hot water is mixed with the ground coffee to produce the coffee extract. In the structure of the conventional portafilter, the filter mesh is entirely distributed with filtration holes. After brewing, the coffee extract flows out through these filtration holes. Therefore, a baffle must be additionally provided at the bottom of the filter mesh to guide the flow, so that the coffee extract flows out from the outlet of the baffle in a concentrated way. The conventional portafilter is complex in structure and high in costs.

### SUMMARY

To solve the above problems, the present invention provides a portafilter and a coffee machine.

To achieve the above objectives, the present invention provides the following technical solution:

A portafilter includes a filter body and a filter basket. The filter body has a receiving chamber. The filter basket is assembled in the receiving chamber of the filter body. The filter basket has a bottom filter mesh. A central region of the bottom filter mesh has a plurality of bottom filtration holes provided at intervals. A peripheral region of the bottom filter mesh is closed.

Further, a diameter of the bottom filtration holes of the bottom filter mesh is 0.2 to 1 mm. The central region of the bottom filter mesh is lower than the peripheral region of the bottom filter mesh. The plurality of bottom filtration holes of the bottom filter mesh are distributed in the circular or polygonal central region.

Further, the bottom filter mesh has a spherical arc or conical structure with a lower center and a higher periphery.

Further, the receiving chamber of the filter body has a chamber structure running through up and down, and the bottom filter mesh of the filter basket corresponds to a bottom opening of the receiving chamber.

Further, the filter basket is further provided with a top filter mesh located above the bottom filter mesh, and the top filter mesh is provided with a plurality of top filtration holes.

Further, a diameter of the top filtration holes of the top filter mesh is 0.1 to 0.5 mm.

Further, the top filter mesh has a middle filtration zone located in a middle, a partition zone located on a periphery of the middle filtration zone, and a peripheral filtration zone located on a periphery of the partition zone. The plurality of top filtration holes of the top filter mesh include a plurality of middle filtration holes provided in the middle filtration zone and peripheral filtration holes provided in the peripheral filtration zone. The middle filtration zone of the top filter mesh is located directly above the central region of the bottom filter mesh.

Further, a spacing between two adjacent middle filtration holes in the middle filtration zone of the top filter mesh is greater than a spacing between two adjacent bottom filtration holes in the central region of the bottom filter mesh.

Further, a total flow area of the top filtration holes of the top filter mesh is greater than a total flow area of the bottom filtration holes of the bottom filter mesh.

Further, the plurality of bottom filtration holes of the bottom filter mesh include a first filtration hole located at a center and second filtration holes located on a periphery of the first filtration hole, and a diameter of the first filtration hole is greater than a diameter of the second filtration holes.

Further, one side of the filter body is provided with a handle.

A coffee machine includes at least the portafilter described above.

The technical solution provided by the present invention has the following beneficial effects:

The central region of the bottom filter mesh is formed with the plurality of bottom filtration holes provided at intervals. Thus, a coffee extract flows from the bottom filtration holes in the central region of the bottom filter mesh, and a water jet is formed in the central region and flows out in a concentrated way. In this way, there is no need for a baffle structure, thereby simplifying the structure and reducing costs.

### BRIEF DESCRIPTION OF DRAWINGS

FIG. 1 is a schematic view of the appearance of a portafilter in Embodiment I;

FIG. 2 is a schematic structural exploded view of the portafilter in Embodiment I;

FIG. 3 is a schematic structural view of a filter basket of the portafilter in Embodiment I;

FIG. 4 is a structural sectional view of the filter basket of the portafilter in Embodiment I;

FIG. 5 is a schematic structural exploded view of the portafilter in Embodiment II;

FIG. 6 is a structural sectional view of the filter basket of the portafilter in Embodiment II;

FIG. 7 is a schematic partial enlarged view of the structure in FIG. 6;

FIG. 8 is a top view of a top filter mesh of the portafilter in an embodiment; and

FIG. 9 is a schematic partial structural view of a bottom filter mesh of the portafilter in an embodiment.

### DESCRIPTION OF EMBODIMENTS

### Embodiment I

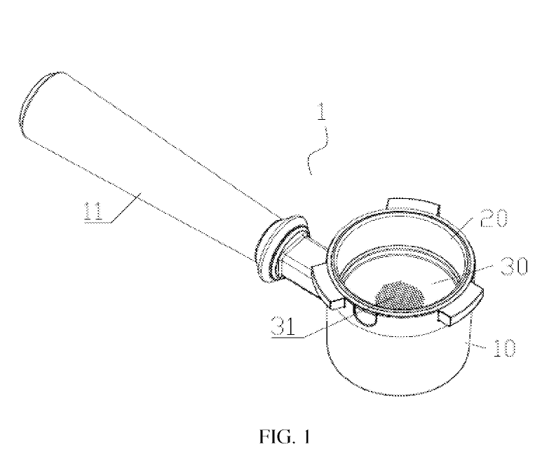

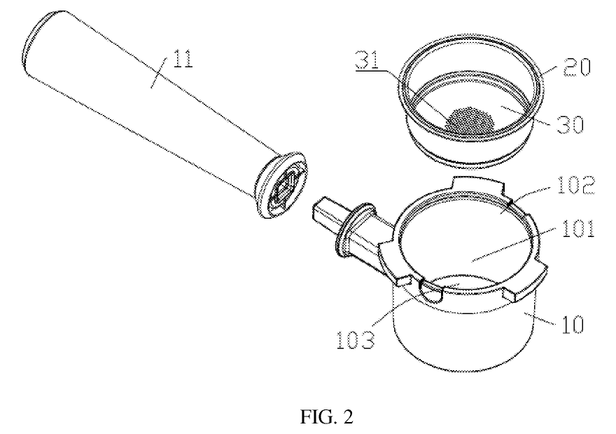

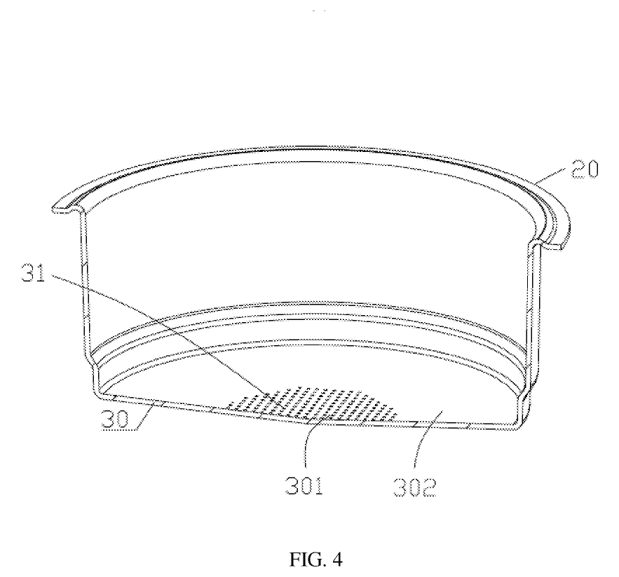

Referring to FIG. 1 to FIG. 4, a portafilter 1 provided in this embodiment includes a filter body 10 and a filter basket 20. The filter body 10 has a receiving chamber 101. The filter basket 20 is assembled in the receiving chamber 101 of the filter body 10. The filter basket 20 has a bottom filter mesh 30. In this embodiment, the filter basket 20 has a single filter mesh structure, i.e., only has the bottom filter mesh 30. A central region 301 of the bottom filter mesh 30 has a plurality of bottom filtration holes 31 provided at intervals. A peripheral region 302 of the bottom filter mesh 30 is closed and is not provided with any filtration hole structure.

During coffee extraction, ground coffee is placed into the filter basket 20. After water is added and pressurized, a brewed coffee extract flows out from the bottom filtration holes 31 in the central region 301 of the bottom filter mesh 30, and a water jet is formed in the central region 301 and flows out in a concentrated way, so that there is no scattering or splashing of the coffee extract. In this way, there is no need for a baffle structure, thereby simplifying the structure and reducing costs.

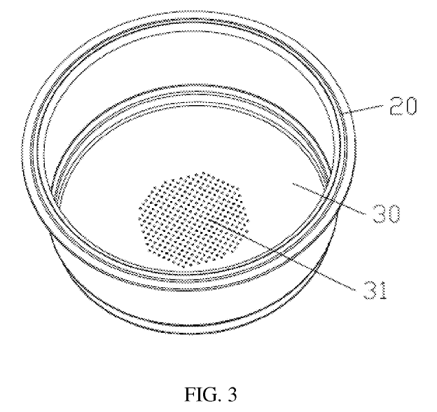

Specifically, as shown in FIG. 3, the plurality of bottom filtration holes 31 of the bottom filter mesh 30 are distributed in the octagonal central region 301. Of course, in other embodiments, the bottom filtration holes may be distributed in the quadrilateral, hexagonal, or other polygonal central region 301, or in the circular, elliptical, or other regular or irregular central region 301.

Further, the central region 301 of the bottom filter mesh 30 is lower than the peripheral region 302 of the bottom filter mesh 30. For example, in this embodiment, the bottom filter mesh 30 has a spherical arc or conical structure with a lower center and a higher periphery, so that the bottom filter mesh 30 gradually slopes down from the peripheral region 302 to the central region 301, providing excellent guidance. Thus, after flowing out from the bottom filtration holes 31 in the central region 301, the coffee extract more easily gathers to form a water jet. Of course, in other embodiments, the bottom filter mesh 30 may also have a flat-bottom structure.

Specifically, the ranges of the central region 301 and the peripheral region 302 of the bottom filter mesh 30 can be set according to actual requirements. For example, the region extending outward from the center point of the bottom filter mesh 30 to one third of the radius may be defined as the central region 301, and the remaining region may be defined as the peripheral region 302. The diameter, shape and quantity of the bottom filtration holes 31 in the central region 301 of the bottom filter mesh 30 and the spacing between two adjacent bottom filtration holes 31 can also be set as needed. As long as the brewed coffee extract can form a water jet in the central region 301 that flows out in a concentrated way, the requirements are met. In this embodiment, a diameter of the bottom filtration holes of the bottom filter mesh is 0.2 to 1 mm.

The receiving chamber 101 of the filter body 10 has a chamber structure running through up and down, that is, the receiving chamber 101 of the filter body 10 is a vertical cylindrical chamber, such that the receiving chamber 101 has a top opening 102 and a bottom opening 103. The filter basket 20 is placed at the top opening 102 of the receiving chamber 101, and the bottom filter mesh 30 of the filter basket 20 corresponds to the bottom opening 103 of the receiving chamber 101. Due to the structure of the bottom filter mesh 30 provided in this application, when receiving the coffee extract, it is only required to align the rim of the cup with the bottom opening 103 of the receiving chamber 101. Of course, in other embodiments, when splitting is required, a splitter may be installed at the bottom opening 103 of the receiving chamber 101.

Specifically, one side of the filter body 10 is provided with a handle 11 for the operator to hold during operation.

This embodiment further provides a coffee machine, including at least the portafilter 1 described above.

### Embodiment II

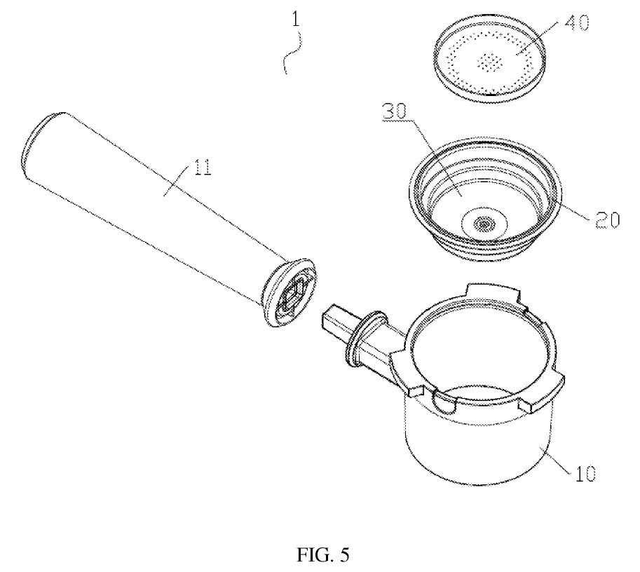

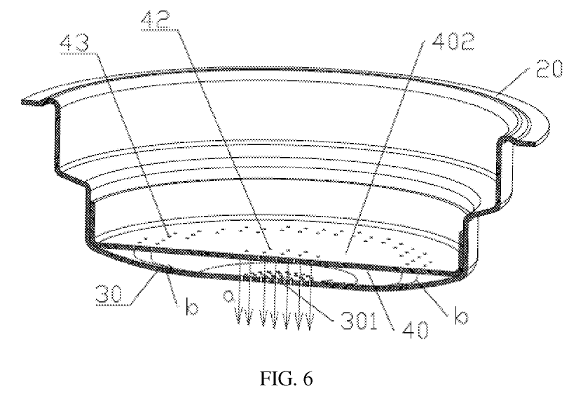

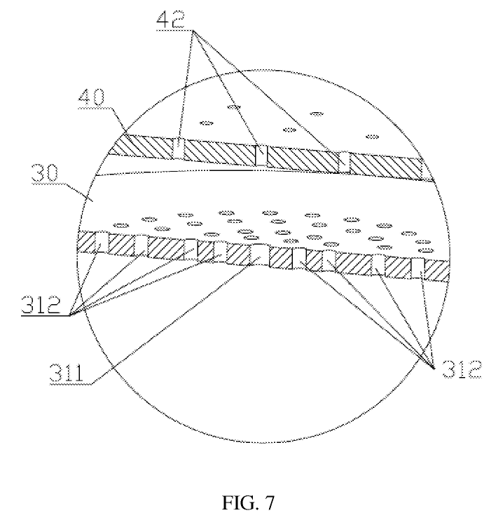

The portafilter 1 provided in this embodiment is generally the same in structure as the portafilter 1 provided in Embodiment I, except that: Referring to FIG. 5 to FIG. 9, in this embodiment, the filter basket 20 is further provided with a top filter mesh 40 located above the bottom filter mesh 30, forming a double filter mesh structure. The top filter mesh 40 is provided with a plurality of top filtration holes 41. During coffee extraction, the coffee extract first flows out through the top filtration holes 41 of the top filter mesh 40, and then flows out through the bottom filtration holes 31 in the central region 301 of the bottom filter mesh 30. In this embodiment, a diameter of the top filtration holes of the top filter mesh is 0.1 to 0.5 mm.

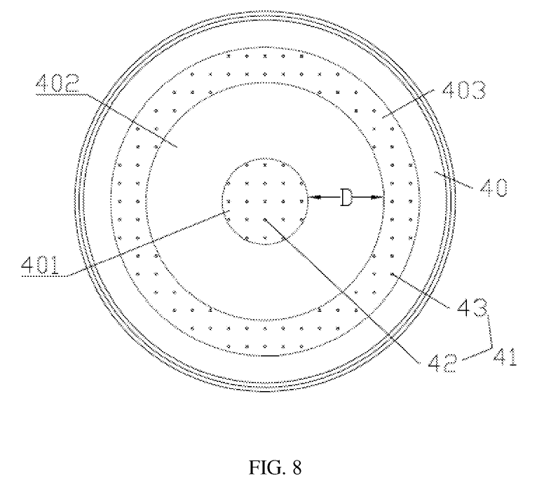

Further, referring to FIG. 8, in this embodiment, the top filter mesh 40 has a middle filtration zone 401 located in a middle, a partition zone 402 located on a periphery of the middle filtration zone 401, and a peripheral filtration zone 403 located on a periphery of the partition zone 402. For distinction, each zone is marked by dashed lines in FIG. 8. The plurality of top filtration holes 41 of the top filter mesh 40 include a plurality of middle filtration holes 42 provided in the middle filtration zone 401 and peripheral filtration holes 43 provided in the peripheral filtration zone 403. A width D of the partition zone 402 is much greater than a distance between two adjacent middle filtration holes 42, and the width D of the partition zone 402 is also much greater than a distance between two adjacent peripheral filtration holes 43. The middle filtration zone 401 of the top filter mesh 40 is located directly above the central region 301 of the bottom filter mesh 30. With this arrangement, the distance from the middle filtration holes 42 of the top filter mesh 40 to the bottom filtration holes 31 in the central region 301 of the bottom filter mesh 30 is much less than the distance from the peripheral filtration holes 43 of the top filter mesh 40 to the bottom filtration holes 31 in the central region 301 of the bottom filter mesh 30. Therefore, the time for the coffee extract flowing out through the peripheral filtration holes 43 of the top filter mesh 40 to reach the bottom filtration holes 31 of the bottom filter mesh 30 is later than that for the coffee extract flowing out through the middle filtration holes 42 to reach the bottom filtration holes 31 of the bottom filter mesh 30. In the initial stage of filtration, the coffee extract flowing out through the middle filtration holes 42 of the top filter mesh 40 first reaches the central region 301 of the bottom filter mesh 30. This flow path a is vertical, so that the coffee extract can directly flow out through the bottom filtration holes 31 in the central region 301 of the bottom filter mesh 30 and easily form a concentrated water jet. However, the coffee extract flowing out through the peripheral filtration holes 43 first falls onto the peripheral region 302 of the bottom filter mesh 30, and is then guided from the peripheral region 302 to the bottom filtration holes 31 in the central region 301. This flow path b is curved. The water jet formed along path a can guide the coffee extract flowing in from path b, ultimately achieving concentrated outflow. This arrangement more effectively avoids the defect of dispersed or split coffee extract output. Moreover, the coffee extract flowing out through the peripheral filtration holes 43 in the peripheral filtration zone 403, when flowing through path b, can carry away water droplets remaining in the peripheral region 302 of the bottom filter mesh 30, thereby preventing the water droplets remaining in the peripheral region 302 of the bottom filter mesh 30 from staying for an extended period and breeding bacteria.

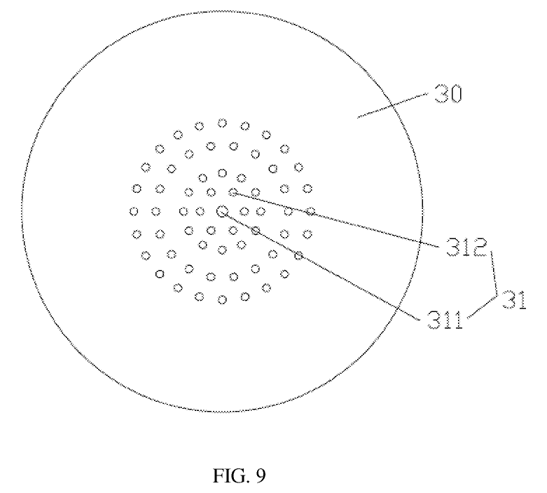

Further, referring to FIG. 9, in this embodiment, the plurality of bottom filtration holes 31 of the bottom filter mesh 30 are distributed in the circular central region 301. The plurality of bottom filtration holes 31 of the bottom filter mesh 30 include a first filtration hole 311 located at a center and second filtration holes 312 located on a periphery of the first filtration hole 311. A diameter of the first filtration hole 311 is greater than a diameter of the second filtration holes 312. For example, the diameter of the first filtration hole 311 is 0.5 mm, and the diameter of the second filtration holes 312 is 0.3 mm. With this arrangement, when the coffee extract first flows out, the larger diameter of the central first filtration hole 311 is more conducive to quickly forming a water jet at the center. Specifically, in this embodiment, there is one first filtration hole 311 located at the very center, and the rest are all the second filtration holes 312. Of course, in other embodiments, there may be a plurality of first filtration holes 311 located at the center. The plurality of bottom filtration holes 31 of the bottom filter mesh 30 may also have equal diameters, and so on.

Specifically, distributing the plurality of bottom filtration holes 31 of the bottom filter mesh 30 in the circular central region 301 is preferable to distributing them in a polygonal central region 301 with corner points. The peripheral bottom filtration holes 31 distributed in the circular central region 301 do not protrude on the periphery, so the coffee extract flowing out from each bottom filtration hole 31 more easily gathers and forms a water jet. However, when the plurality of bottom filtration holes 31 are distributed in the polygonal central region 301 with corner points, the bottom filtration holes 31 located at the corner points on the periphery protrude individually, so the coffee extract flowing out from the bottom filtration holes 31 at the corner points on the periphery does not easily gather with the coffee extract flowing out from other positions, causing separated water jets during the early stage of coffee brewing.

Further, in this embodiment, a spacing between two adjacent middle filtration holes 42 in the middle filtration zone 401 of the top filter mesh 40 is greater than a spacing between two adjacent bottom filtration holes 31 in the central region 301 of the bottom filter mesh 30. That is, a density of the plurality of bottom filtration holes 31 is higher than a density of the middle filtration holes 42. In this way, when the coffee extract flowing out through the plurality of middle filtration holes 42 in the middle filtration zone 401 of the top filter mesh 40 flows to the plurality of bottom filtration holes 31 below and then flows out of the bottom filtration holes 31, the water jet becomes more concentrated, resulting in a better guiding effect for the coffee extract flowing out via path b on the periphery.

Further, in this embodiment, a total flow area of the top filtration holes 41 of the top filter mesh 40 is greater than a total flow area of the bottom filtration holes 31 of the bottom filter mesh 30. Specifically, the amount of the coffee extract flowing out through the top filter mesh 40 per unit time is greater than the amount of the coffee extract flowing out of the bottom filter mesh 30. Therefore, the external extraction pressure applied to the filter basket 20 acts simultaneously on both the top filter mesh 40 and the bottom filter mesh 30, and both the top filter mesh 40 and the bottom filter mesh 30 withstand a certain pressure, which is beneficial for increasing the extraction pressure, thereby maintaining the extraction pressure of the filter basket 20 effectively.

This embodiment discloses one preferred technical solution for the double filter mesh structure. Of course, other embodiments are not limited thereto. For example, the top filter mesh 40 adopts a structure only with the plurality of middle filtration holes 42 in the middle filtration zone 401, or the top filter mesh 40 adopts a structure with the top filtration holes 41 distributed over the entire surface, and so on.

This embodiment further provides a coffee machine, including at least the portafilter 1 described above.

Although the present invention has been specifically shown and described with reference to preferred implementations, those skilled in the art should understand that various changes in form and detail may be made without departing from the spirit and scope of the present invention as defined by the appended claims, and all such changes are within the protection scope of the present invention.

1. A portafilter, comprising a filter body and a filter basket, wherein the filter body has a receiving chamber, the filter basket is assembled in the receiving chamber of the filter body, the filter basket has a bottom filter mesh, a central region of the bottom filter mesh has a plurality of bottom filtration holes provided at intervals, and a peripheral region of the bottom filter mesh is closed.

2. The portafilter according to claim 1, wherein a diameter of each of the plurality of bottom filtration holes of the bottom filter mesh is 0.2 to 1 mm, the central region of the bottom filter mesh is lower than the peripheral region of the bottom filter mesh, and the central region has a circular or polygonal shape.

3. The portafilter according to claim 1, wherein the receiving chamber of the filter body has a chamber structure extending vertically, and the bottom filter mesh of the filter basket corresponds to a bottom opening of the receiving chamber.

4. The portafilter according to claim 1, wherein the filter basket is further provided with a top filter mesh located above the bottom filter mesh, the top filter mesh is provided with a plurality of top filtration holes, and a diameter of each of the plurality of top filtration holes of the top filter mesh is 0.1 to 0.5 mm.

5. The portafilter according to claim 4, wherein the top filter mesh has a middle filtration zone located in a middle, a partition zone located on a periphery of the middle filtration zone, and a peripheral filtration zone located on a periphery of the partition zone, the plurality of top filtration holes of the top filter mesh comprise a plurality of middle filtration holes provided in the middle filtration zone and peripheral filtration holes provided in the peripheral filtration zone, and the middle filtration zone of the top filter mesh is located directly above the central region of the bottom filter mesh.

6. The portafilter according to claim 5, wherein a spacing between two adjacent middle filtration holes of the plurality of middle filtration holes in the middle filtration zone of the top filter mesh is greater than a spacing between two adjacent bottom filtration holes of the plurality of bottom filtration holes in the central region of the bottom filter mesh.

7. The portafilter according to claim 4, wherein a total flow area of the plurality of top filtration holes of the top filter mesh is greater than a total flow area of the plurality of bottom filtration holes of the bottom filter mesh.

8. The portafilter according to claim 1, wherein the plurality of bottom filtration holes of the bottom filter mesh comprise a first filtration hole located at a center and second filtration holes located on a periphery of the first filtration hole, and a diameter of the first filtration hole is greater than a diameter of each of the second filtration holes.

9. The portafilter according to claim 5, wherein a total flow area of the plurality of top filtration holes of the top filter mesh is greater than a total flow area of the plurality of bottom filtration holes of the bottom filter mesh.

10. The portafilter according to claim 4, wherein the plurality of bottom filtration holes of the bottom filter mesh comprise a first filtration hole located at a center and second filtration holes located on a periphery of the first filtration hole, and a diameter of the first filtration hole is greater than a diameter of each of the second filtration holes.

11. A coffee machine, comprising the portafilter according to claim 1.

12. The coffee machine according to claim 11, wherein a diameter of each of the plurality of bottom filtration holes of the bottom filter mesh is 0.2 to 1 mm, the central region of the bottom filter mesh is lower than the peripheral region of the bottom filter mesh, and the central region has a circular or polygonal shape.

13. The coffee machine according to claim 11, wherein the receiving chamber of the filter body has a chamber structure extending vertically, and the bottom filter mesh of the filter basket corresponds to a bottom opening of the receiving chamber.

14. The coffee machine according to claim 11, wherein the filter basket is further provided with a top filter mesh located above the bottom filter mesh, the top filter mesh is provided with a plurality of top filtration holes, and a diameter of each of the plurality of top filtration holes of the top filter mesh is 0.1 to 0.5 mm.

15. The coffee machine according to claim 14, wherein the top filter mesh has a middle filtration zone located in a middle, a partition zone located on a periphery of the middle filtration zone, and a peripheral filtration zone located on a periphery of the partition zone, the plurality of top filtration holes of the top filter mesh comprise a plurality of middle filtration holes provided in the middle filtration zone and peripheral filtration holes provided in the peripheral filtration zone, and the middle filtration zone of the top filter mesh is located directly above the central region of the bottom filter mesh.

16. The coffee machine according to claim 15, wherein a spacing between two adjacent middle filtration holes of the plurality of middle filtration holes in the middle filtration zone of the top filter mesh is greater than a spacing between two adjacent bottom filtration holes of the plurality of bottom filtration holes in the central region of the bottom filter mesh.

17. The coffee machine according to claim 14, wherein a total flow area of the plurality of top filtration holes of the top filter mesh is greater than a total flow area of the plurality of bottom filtration holes of the bottom filter mesh.

18. The coffee machine according to claim 11, wherein the plurality of bottom filtration holes of the bottom filter mesh comprise a first filtration hole located at a center and second filtration holes located on a periphery of the first filtration hole, and a diameter of the first filtration hole is greater than a diameter of each of the second filtration holes.

19. The coffee machine according to claim 15, wherein a total flow area of the plurality of top filtration holes of the top filter mesh is greater than a total flow area of the plurality of bottom filtration holes of the bottom filter mesh.

20. The coffee machine according to claim 14, wherein the plurality of bottom filtration holes of the bottom filter mesh comprise a first filtration hole located at a center and second filtration holes located on a periphery of the first filtration hole, and a diameter of the first filtration hole is greater than a diameter of each of the second filtration holes.
